(19) United States
(12) Patent Application Publication
(10) Pub. No.: US 2009/0180283 A1
(43) Pub. Date: Jul. 16, 2009

(54) Projecting Head for a Laser Pointer for Presenting Different Projected Patterns

(76) Inventor: Heng-Ping Chu, Gueishan Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/013,604

(22) Filed: Jan. 14, 2008

(51) Int. Cl. G02B 27/20

(52) U.S. Cl. 362/259

(57) ABSTRACT

A projecting head of a laser pointer has a base, a gear wheel, a positioning stage and a cap. The base has a front end and a laser channel. The laser channel is formed through the base to allow a laser light to pass through. The gear wheel is mounted rotatably on the front end of the base and has multiple different imaging patterns. Each imaging pattern selectively covers the front opening of the laser channel of the base when rotating the gear wheel. The positioning stage holds the gear wheel between the base and the positioning stage and has a passage that allows the laser light to pass through. The cap has an annular gear engaging the gear wheel. Therefore, the gear wheel will rotate when the cap is rotated. Consequently, the projecting head will follow the rotating gear wheel to present different projected patterns.

### BACKGROUND OF THE INVENTION

1. Field of the Invention

The present invention relates to a projecting head of a laser pointer, and more particularly to a projecting head of a laser pointer for presenting different projected patterns.

2. Description of Related Art

Laser pointers are commonly used during presentations. Presenters can easily point out what to focus on to the listeners because each laser pointers emits laser lights and presents a projected pattern on a presenting screen.

A conventional laser pointer has a stick shaped housing, a laser module and a collimater. An end of the housing has a through hole. The laser module is mounted in the housing and generates and emits light. The collimator is mounted in the housing and collimates the light emitted from the laser module. The collimated light is then projected from the through hole of the housing and presents a dot image on the presenting screen.

Another conventional laser pointer further has multiple detachable projecting heads. Each projecting head can be detachably mounted on one end of the housing and has an imaging pattern so the laser pointer can present different replaceable projected patterns.

However, the presenter has to inconveniently change different projecting heads to show different projected patterns during presentations.

To overcome the shortcomings, the present invention provides a projecting head of a laser pointer for presenting different projected patterns to mitigate or obviate the aforementioned problems.

### SUMMARY OF THE INVENTION

The main objective of the invention is to provide a projecting head of a laser pointer for presenting different projected patterns.

The projecting head in accordance with the present invention comprises a base, a gear wheel, a positioning stage and a cap. The base has a front end and a laser channel. The laser channel is formed in and through the base to allow a laser light to pass through. The gear wheel is mounted rotatably on the front end of the connecting base and has multiple different imaging patterns. Each imaging pattern selectively covers the front opening of the laser channel of the base when rotating the gear wheel. The positioning stage sandwiches the gear wheel in between the base and the positioning stage and has a passage that allows the laser light to pass through. The cap has an annular gear engaging with the gear wheel. Therefore, the gear wheel will rotate when the cap is rotated. Consequently, the projecting head will follow the rotating gear wheel to present different projected patterns.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a projecting head in accordance with the present invention, and a laser pointer;

FIG. 2 is a front exploded perspective view of the projecting head in FIG. 1;

FIG. 3 is a rear exploded perspective view of the projecting head in FIG. 1;

FIG. 4 is a side view in partial section of the projecting head connected to the laser pointer in FIG. 1; and

FIG. 5 is a front view in partial section of the projecting head in FIG. 1.

### DETAILED DESCRIPTION OF PREFERRED EMBODIMENT

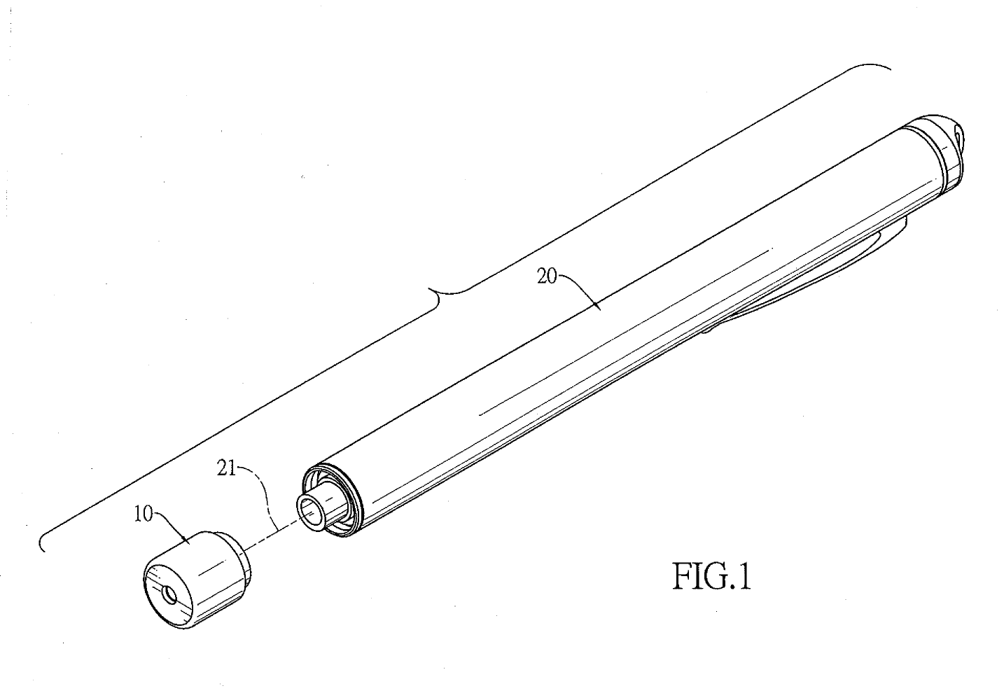

With reference to FIG. 1, a projecting head (10) for presenting different projected patterns in accordance with the present invention is mounted on a laser pointer (20) that emits a laser light through a laser emitting route.

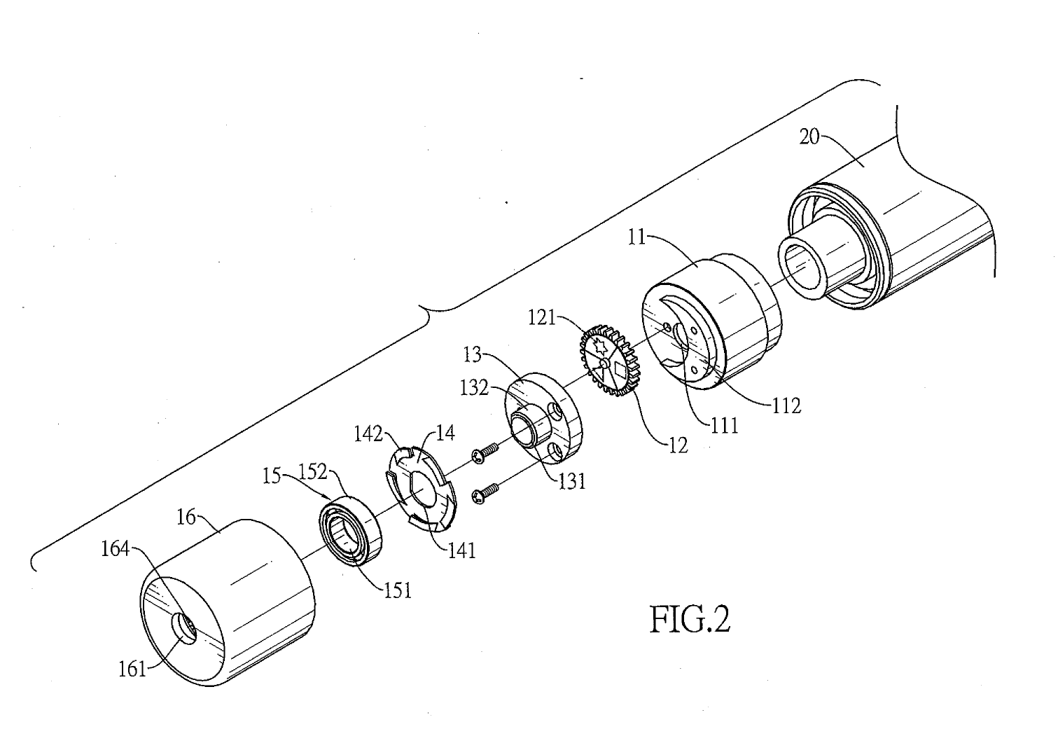

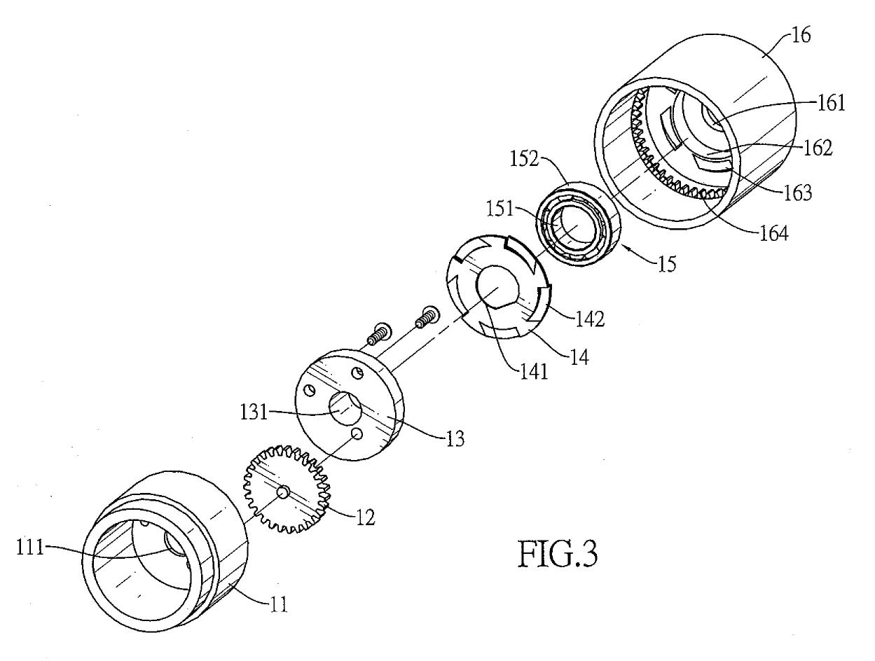

With further reference to FIGS. 2 and 3, the projecting head (10) comprises a base (11), a gear wheel (12), a positioning stage (13), an optional ratchet (14), an optional bearing (15) and a cap (16).

The base (11) has a front end, a rear end, a laser channel (111) and an optional protrusion (112). The rear end of the base (11) is mounted on the laser pointer (20). The laser channel (111) is formed through the base (11), corresponds to the laser emitting route of the laser pointer (20) to allow the laser lights to pass through the base (11). The protrusion (112) is formed on the front end of the base (11).

The gear wheel (12) is mounted rotatably on the front end of the base (11), is adjacent to and covers the front opening of the laser channel (111) of the base (11), has multiple different imaging patterns and may be diffraction optical film that diffracts the laser light. The imaging patterns are formed on the gear wheel (12), and each imaging pattern selectively corresponds to the front opening of the laser channel (111) of the base (11) when the gear wheel (12) is rotated to present a projected pattern on a screen and when the gear wheel (12) is made of diffraction optical film, each imaging pattern may be a grating pattern to diffract the laser lights. Furthermore, the gear wheel (12) may be separated into multiple equal segments and have multiple imaging patterns formed respectively on the multiple equal segments of the gear wheel (12). For example, three imaging patterns may be formed respectively on three segments of the gear wheel (12), and the three imaging patterns are a square, a star and a triangle.

The positioning stage (13) is mounted on the front end of the base (11) to hold the gear wheel (I 2) against the base (11) and the positioning stage (13) and may be connected securely to the protrusion (112) on the base (11) with screws (133) and has a front end, a rear end, an optional protrusion (132) and a passage (131). The protrusion (132) is formed on the front end of the positioning stage (13) and has a front end. The passage (131) is formed through the positioning stage (13) and may be through the protrusion (132) and corresponds to the laser channel (111) of the base (11).

The ratchet (14) is mounted on the front end of the positioning stage (13) and has a front surface, an edge, a through hole (141) and multiple teeth (142). The through hole (141) is formed on the ratchet (14) and corresponds to the protrusion (132) of the positioning stage (13). The teeth (142) are formed on the front surface of the ratchet (14) and at the edge of the ratchet (14). Furthermore, the teeth (142) maybe stamped clockwise on the front surface of the ratchet (14).

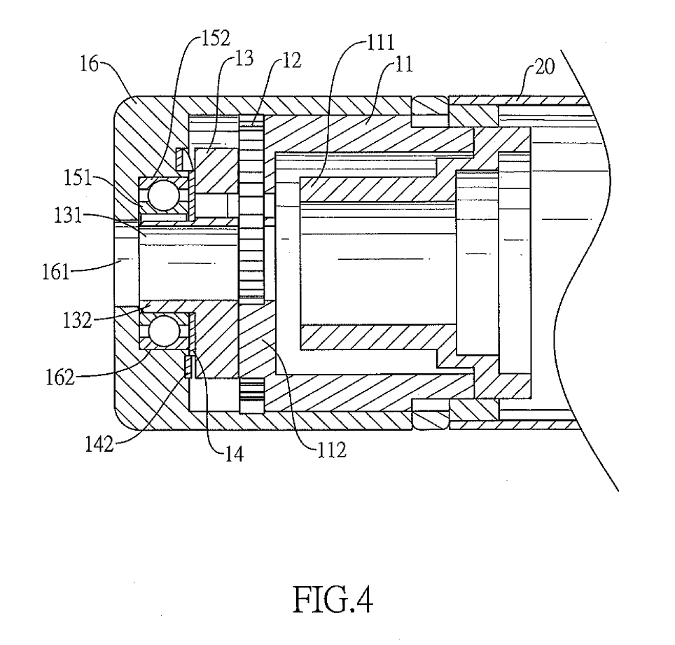

With further reference to FIG. 4, the bearing (15) is mounted on the front end of the front surface of the ratchet (14) and has an inner ring (151) and an outer ring (152). The inner ring (151) is mounted securely on the protrusion (132) of the positioning stage (13) to give smooth motion.

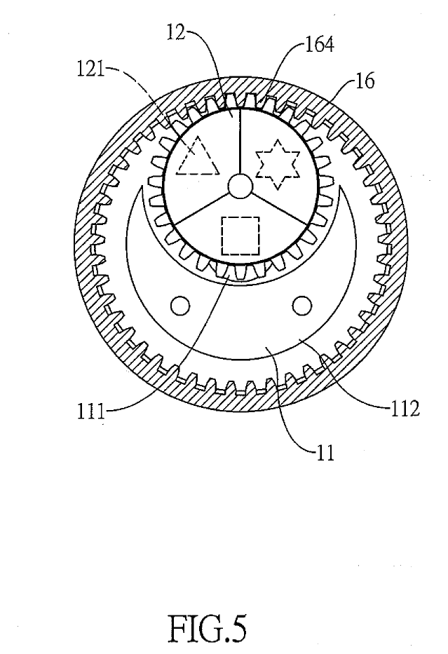

The cap (16) covers the bearing (15), the ratchet (14), the positioning stage (13), the gear wheel (12) and the base (11) and has a front end, an inner surface, a window (161), an optional engaging section (162), multiple optional detents (163) and an annular gear (164). The window (161) is formed on the front end of the cap (16) and corresponds to the front opening of the passage (131) of the positioning stage (13). The engaging section (162) is formed on the inner surface in the cap (16) and securely engages the outer ring (152) of the bearing (15). The detents (163) are formed on the inner surface of the cap (16) and correspond respectively to the teeth (142) on the ratchet (14). Furthermore, the detents (163) may be formed clockwise on the inner surface of the cap (16) when the teeth (142) are formed clockwise on the ratchet (14) so the cap (16) is capable of rotating clockwise but not rotating counterclockwise. The annular gear (164) is formed on the inner surface of the cap (16) and engages the gear wheel (12) to drive the gear wheel (12) to rotate when the cap (16) is rotated. Therefore, with further reference to FIG. 5, rotating the cap (16) changes different imaging patterns positioned at the front opening of the laser channel (111) of the base (11). Different imaging patterns on the laser emitting route results in different projected patterns presented on a screen by the laser pointer (20) with the projecting head (10).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A projecting head for presenting different projected patterns being mounted on a laser pointer that emits a laser light through a laser emitting route comprising:
a base having
a front end;
a rear end being mounted on the laser pointer; and
a laser channel being formed through the base, corresponding to the laser emitting route of the laser pointer;
a gear wheel being mounted rotatably on the front end of the base, being adjacent to and covering the front opening of the laser channel of the base and having
multiple different imaging patterns formed on the gear wheel, and each imaging pattern selectively corresponding to the front opening of the laser channel of the base by rotating the gear wheel;
a positioning stage being mounted on the front end of the base to hold the gear wheel against the base and the positioning stage and having
a front end;
a rear end; and
a passage being formed through the positioning stage and corresponding to the laser channel of the base; and
a cap covering the positioning stage the gear wheel and the base and having
a front end;
an inner surface;
a window being formed on the front end of the cap corresponding to the front opening of the passage of the positioning stage; and
an annular gear being formed on the inner surface of the cap and engaging the gear wheel to drive the gear wheel rotationally when the cap is rotated so as to present different projected patterns with the different imaging patterns.

2. The projecting head as claimed in claim 1, wherein
the gear wheel is made of diffraction optical film that diffracts the laser light.

3. The projecting head as claimed in claim 1, wherein the gear wheel is separated into multiple segments and has multiple imaging patterns formed respectively on the multiple segments of the gear wheel.

4. The projecting head as claimed in claim 1 further comprising a bearing, wherein
the positioning stage further has a protrusion being formed on the front end of the positioning stage and having a front end;
the passage of the positioning stage is further formed through the protrusion of the positioning stage;
the bearing is mounted on the front end of the positioning stage and has
an inner ring being mounted securely on the protrusion of the positioning stage; and
an outer ring; and
the cap further covers the bearing and has an engaging section being formed on the inner surface of the cap and securely engaging the outer ring of the bearing.

5. The projecting head as claimed in claim 4 further comprising
a ratchet being mounted on the front end of the positioning stage and having
a front surface;
an edge;
a through hole being formed on the ratchet and corresponding to the protrusion of the positioning stage; and
multiple teeth being formed on the front surface of the ratchet and at the edge of the ratchet; and
the cap further covers the ratchet and has multiple detents being formed on the inner surface of the cap and corresponding respectively to the teeth on the ratchet.

6. The projecting head as claimed in claim 5, wherein
the teeth of the ratchet are formed clockwise on the front surface of the ratchet; and
the detents are formed clockwise on the inner surface of the cap.

7. The projecting head as claimed in claim 1, wherein the base further has a protrusion formed on the front end of the base.

8. The projecting head as claimed in claim 7, wherein the positioning stage is connected securely to the protrusion on the base with screws.
